(19) United States
(12) Patent Application Publication
(10) Pub. No.: US 2005/0288394 A1
(43) Pub. Date: Dec. 29, 2005

(54) Insulative, emissive and reflective coating

(76) Inventors: John Rothman, Lebanon, NJ (US); Jack Wiersma, Palm Beach Gardens, FL (US)

Correspondence Address: MCHALE & SLAVIN, P.A., 2855 PGA BLVD, PALM BEACH GARDENS, FL, 33410, US

(21) Appl. No.: 10/880,330

(22) Filed: Jun. 29, 2004

(51) Int. Cl. C09D 5/16; C08J 9/32

(52) U.S. Cl. 523/219; 106/18.12; 106/18.13; 106/18.16

(57) ABSTRACT

The present invention is directed towards a coating composition for retarding fire and for substantially eliminating temperature increase of surfaces and/or structures exposed to forms of radiant energy such as solar radiation; particularly towards coating compositions having properties of emissivity, insulation, diffuse reflectivity, emittance, and fire retardant properties effective to eliminate a majority of the heat duty which results from incident heat and radiation impinging upon the surface/structure, and most particularly towards a coating composition containing both fractionally endothermic constituents capable of consuming incident heat, as well as a plurality of evacuated borosilicate microspheres of a size distribution and density effective to maximize properties of diffusive reflectivity and emissivity. The coating functions to both keep elevated temperatures out of enclosed spaces or to confine elevated temperatures within enclosed spaces.

### FIELD OF THE INVENTION

The present invention is directed towards a coating composition for reducing the transfer of heat and providing protection from the consequences of heat generated by either the transduction of radiant energy into heat (e.g. sunlight) or by fire. The invention presented herein operates through the combined mechanisms of reflectivity, emissivity, insulation and conformational changes in constituents used previously in fire retardants. Where the inhibition of the conversion of solar radiation to heat is desired, a coating composition containing high albedo excipients and a plurality of evacuated borosilicate microspheres of a size distribution and density effective to maximize properties of diffuse reflectivity and emissivity; and furthermore to fire retardant coatings additionally containing fire retardant components e.g. endothermic constituents such as ammonium polyphosphate and monoammonium phosphate characterized as undergoing a conformational change that prevents heat transfer. The coating functions to fireproof and fire resist, and to prevent the transduction of radiant energy into heat, which keeps elevated temperatures out of enclosed spaces or to confining elevated temperatures within enclosed spaces. In the case of fire retardation, a high albedo compound is not necessary, but substantially higher ratios of known fire retarding compounds such as phosphate salts are required.

### BACKGROUND OF THE INVENTION

The ability to control and/or modify heat production and generation on irradiated surfaces has been explored utilizing a variety of technologies. The Federal Energy Management Program has utilized a sprayed on polyurethane foam system coupled with a seal coat of polyurea and a topcoat of small hollow borosilicate microspheres to produce a coating which lowers temperatures by about 35%. Federal buildings at Tyndall Air Force Base have likewise benefited from the use of radiation control coatings formed from acrylic and latex compositions including ceramic beads and reflective pigments. The Rohm and Haas corporation has likewise experimented with various elastomeric coatings containing reflective and insular components.

The prior art has failed to appreciate the enhanced properties which can be attained when a number of disparate mechanisms are combined within a single homogeneous coating composition or system, whereby highly efficacious results in terms of fire retardation and energy savings can be achieved.

The present invention optimizes a plurality of disparate mechanisms of action including emissivity, reflectivity, insulation and conformational endothermic changes to prevent the formation of heat on irradiated surfaces whether due to solar radiation or fire. Additionally, the present invention is a technology that can be embodied in various coating vehicles such as acrylic paints, pure or hybrid polyureas, polyurethane foams and the like vehicles effective for providing fireproofing or heat reduction wherever it is required.

In one preferred, albeit non-limiting embodiment, the present invention utilizes partially evacuated borosilicate microspheres which have been selected based upon their physical characteristics, so as to provide optimum insulating properties and control of incident radiation, while enabling application via high pressure spray techniques and the like.

While the use of evacuated glass microspheres, reflective pigments and fire retardant chemicals has been recognized for some time, the prior art has failed to provide an optimum system for utilizing these disparate mechanisms in combination, so as to provide a highly efficacious surface coating.

### DESCRIPTION OF THE PRIOR ART

U.S. Pat. No. 4,303,732 to Torobin teaches the use of evacuated borosilicate microspheres, which may contain a reflective layer within or outside of the microsphere.

U.S. Pat. No. 5,713,974 to Martin et al. is directed toward evacuated microspheres, insulating materials constructed from such microspheres, and methods of manufacturing same to provide insulation and reduce heat transfer through radiation, conduction and convection. Additionally, an infrared reflective coating is provided on a microsphere surface to reduce radiant heat transfer. A protective exterior coating is also provided to protect an exteriorly applied infrared reflective coating on such a microsphere. Furthermore, the spheroid geometry of such microspheres restricts heat transfer to point-to-point conduction therebetween. Finally, evacuated microspheres are taught to further reduce through-heat transfer within a shell. One embodiment utilizes such evacuated microspheres in constructing an elastomeric roof coating which appreciably reduces cooling and air conditioning power costs for a building. An alternative embodiment utilizes such an elastomeric coating in constructing an exterior paint for a building. A method of evacuating such microspheres involves in-permeation of selected gases within a microsphere which reacts under sufficiently high temperatures with residual gases within the microsphere to produce by-product gases which out-permeate from within the sphere under sufficiently high temperatures. Furthermore, a method of constructing suitable glass microspheres which are suitable for evacuating via out-permeation is also described.

U.S. Pat. No. 5,972,434 teaches fire resistant glass fiber products which are produced by coating the glass fibers with at least one nitrogen containing compound and at least 10 weight percent of at least one boron containing compound, drying the glass fibers and curing a binder that is in the coating. The nitrogen containing compound(s) are present in sufficient amounts that there is at least one mol or atom of nitrogen present for each mol or atom of boron present in the boron containing compound(s). When the product is exposed to a fire or high temperatures, such as about 1000 degrees F. or higher, the nitrogen released from the nitrogen containing compound(s) reacts with boron or boron oxide to form a sheath of refractory material around the fibers that protects the fibers and allows the fibers to maintain integrity to higher temperatures and/or for longer times than untreated fibers.

U.S. Pat. No. 5,942,288 describes a fiber glass mat composition comprising a fiber glass matrix bonded with fire retardant melamine resin binder composition capable of forming a nonwoven mat having at least 27% by weight nitrogen (N) in the dry, but uncured resin. Also described is a method of making a fire retardant non-woven fiber glass mat comprising the steps of providing an aqueous melamine based resin binder; applying the binder to fiber glass; and recovering a fire retardant fiber glass mat, wherein the mat has at least 27% by weight N in the dry, but uncured resin wherein the ratio of resin in the mat to N content of the resin does not exceed about 0.6.

U.S. Pat. No. 5,840,413 Described is a fiber glass mat composition comprising a fiber glass matrix bonded with fire retardant melamine resin binder composition capable of forming a non-woven mat having at least 27% by weight nitrogen (N) in the dry, bur uncured resin. Also described is a method of making a fire retardant non-woven fiber glass mat comprising the steps of providing an aqueous melamine based resin binder; applying the binder to fiber glass; and recovering a fire retardant fiber glass mat, wherein the mat has at least 27% by weight N in the dry, but uncured resin wherein the ratio of resin in the mat to N content of the resin does not exceed about 0.6.

U.S. Pat. No. 5,837,621 teaches fire resistant glass fiber products produced by coating the glass fibers with at least one nitrogen containing compound and at least 10 weight percent of at least one boron containing compound, drying the glass fibers and curing a binder that is in the coating. The nitrogen containing compound(s) are present in sufficient amounts that there is at least one mol or atom of nitrogen present for each mol or atom of boron present in the boron containing compound(s). When the product is exposed to a fire or high temperatures, such as about 1000 degrees F. or higher, the nitrogen released from the nitrogen containing compound(s) reacts with boron or boron oxide to form a sheath of refractory material around the fibers that protects the fibers and allows the fibers to maintain integrity to higher temperatures and/or for longer times than untreated fibers.

U.S. Pat. No. 5,763,343 teaches hard glass fire retardant glasses which can be tempered in a conventional air tempering plant having heat transmission values of approximately 200-500 W/(m²xK) yielding in the tempered state a fire resistance period of at least 30 minutes according to DIN 4102 and the safety properties according to DIN 1249 (safe break). In order to achieve the combination of fire resistance period and safety properties, the glasses must have a coefficient of thermal expansion α_{20/300} of between 3 and 6×10⁻⁶K⁻¹, a specific thermal stress Ø of between 0.3 and 0.5 N/(mm²xK), a glass transition temperature Tg of Ø between 535 degree and 850 degree C. a product of specific thermal stress Ø multiplied by (Tg −20 degree C.) of between 180 and 360 N/mm², an upper annealing temperature (temperature at a viscosity of 10¹³ dpas) of over 560 degree C., a softening temperature (temperature at a viscosity of 107^{7.6} dpas) of over 830 degree C. and a working temperature (temperature at a viscosity of 10⁴ dpas) of below 1300 degree C.

U.S. Pat. No. 5,262,454 discloses a flame-resistant, hardenable polyorganosiloxane compound is described with a content of 2 to 40 weight % hollow glass balls with an outside diameter of up to 200μm and 3 to 50 weight % of an inorganic intumescent compound which expands at a temperature from 80 degree to 250 degree C. The preferred intumescent compound is expandable graphite. The compound can replace the previous compounds provided with polyhalogenated diphenyl compounds in fireproof windows.

U.S. Pat. No. 4,168,175 is directed toward fire retardant generally non-caking compositions of intimately intermixed ammonium phosphate, e.g. mono-and/or diammonium phosphate; sodium tetraborate containing molecularly bound water, e.g. the decahydrate borax; and fractured finely ground solid powder particles of soda-containing silicate glass which have a high and irregular surface area and an active dry moisture absorbent surface condition for maintaining the particles of ammonium phosphate and sodium tetraborate in moisture protected disposition and for inhibiting the tendency of such particles to adhere to one another; the three components having an average particle size below about 4 mesh, the ammonium phosphate and sodium tetraborate being present in a combined predominant amount effective for imparting an active fire retarding property to cellulosic materials, and the resulting admixture being substantially dry and free flowing with the individual particles thereof in substantially uniform and non-caking distribution; Corresponding combinations of such compositions with fibers of cellulosic material forming composite fire retardant products in which the three components are in substantially uniform distribution throughout the cellulosic material and in intimate association with the corresponding fibers thereof, and particularly loose fill structural products in which the individual particles of glass, borax and phosphate are disposed in situ in entwined relation with the adjacent cellulosic fibers; and Methods of preparing such composition in the substantial absence of moisture and of autogenous mixing heat, and in turn methods of preparing such composite fire retardant products.

What has heretofore been lacking in the art is a coating, coating system (top coat and primer) or a solid material(s) which will substantially reduce the internal temperature or reduce the thermal signature of structures exposed to radiant energy that is comprised of reflective, emissive and insular materials, such that high loading of microscopic granules lead to a concomitant increase in surface area thereby creating diffuse reflectivity and a consequential increase in emissivity, while simultaneously providing fire retardant and heat transfer reducing properties.

### SUMMARY OF THE INVENTION

The present invention makes use of the physical and chemical properties of various constituents in order to achieve a significant increase in the properties of reflectance, emittance, emissivity, insulation, and endothermic conformational changes which, in combination, result in substantial reduction in heat duties. This invention incorporates the property of diffuse reflectivity which results in increased emissivity. Diffusion of reflectance is obtained by the use of granular agents in the low micron range to dramatically increase the surface area of the exposed surface of any substrate which either incorporates this technology or to which this technology is applied. When this principal is applied in formulations with ingredients that have high reflectivity, high emissivity, as well as insulation properties and fractional endothermic changes resulting from exposure to heat, the result is a dramatic reduction in transmitted temperature, owing to the effect of all four mechanisms of action on the three mechanisms of heat transfer: radiation, convection, and conduction.

If the formulation further uses materials with low thermal conductance, and thus imparts insulating properties, and further includes excipients that absorb heat by using exogenous thermal energy to produce endothermic conformational changes (said excipients taught, for example, by Schmittmann et al (U.S. Pat. No. 4,438,028) the contents of which are herein incorporated by reference), additional thermal protection is afforded. Since the transduction of energy into heat is an inefficient process, only a very small percentage of the energy which strikes the surface is converted into heat energy. The result of this is that, for example, a roof surface which might measure approximately 160° F. on a 90° F. day will measure only about 93° F. when treated with this technology.

Accordingly, it is an objective of the instant invention to teach a method for preventing the heating by radiant energy of structures, storage tanks, vehicles, tents, clothing, or any surface that would benefit from protection from fire or the inhibition of heat formation due to impinging radiant energy.

It is a further objective of the instant invention to teach a coating, coating system or article of manufacture having properties of reflectance, emittance, emissivity, insulation and fractional endothermic conformational changes effective to provide a significant reduction in heat duty of a surface or structure.

It is yet another objective of the instant invention to provide a coating for reducing the heat signature of a surface or structure.

It is a further objective of the instant invention to teach a coating, coating system or article of manufacture having properties of reflectance, emittance, emissivity and insulation which further includes one or more ingredients capable of endothermic conformational responses, e.g. endothermic salts, agents which release complexed water, and so forth, whereby enhanced efficacy and utility as a fire resistant material is achieved.

Yet another objective of this invention is to provide a novel method of fireproofing surfaces by retarding the advancement of fire by using the many disparate mechanisms discussed above.

Other objects and advantages of this invention will become apparent from the following description, wherein are set forth, by way of illustration and example, certain embodiments of this invention.

### DETAILED DESCRIPTION OF THE INVENTION

The instant invention is directed towards a coating, coating system or article of manufacture which substantially prevents the transduction ofradiant energy (e.g. sunlight) into heat using four mechanisms:

Reflectivity—as used herein refers to the optical property of reflectance, wherein radiation impinging upon a surface is reflected backward therefrom, and is the ratio of solar radiation reflected by a surface to that received by it.

Emissivity—the ratio of radiant energy from a material to that from a blackbody at the same kinetic temperature. Materials may have wavelength-dependent emissivities between 0 and 1.0 (approximately the inverse of reflectance).

Insulation—as used herein refers to retardation of the passage of heat, typically designated as an “R” value. The instantly disclosed material has an R value of about 5.

Endothermic conformational changes—as used herein refers to the heat transfer reduction which results from the exposure of certain chemicals, e.g. phosphate salts, to thermal energy, wherein said energy is consumed by the generation of endothermic molecular changes which result in a lower energy conformation (e.g. configurational changes to higher oxidation states, the release of complexed water, and so forth).

Reflectivity results from the addition of bright white pigments. Illustrative of which is Titanium Dioxide (TiO₂), although other materials and colors are contemplated by the present invention. Additional reflectivity is obtained through the addition of borosilicate microspheres, which are tiny glass beads that reflect. Similarly, other glass additives (chips, fragments) may be useful in providing a similar effect.

Emissivity results from the inclusion of microscopic beads, typically in the 5-20 micron range. Addition of beads in this size range provides a microscopic pebbling to the surface whereby a diffuse reflector is created. Diffuse reflection is accompanied by emissivity. Illustrative of agents that provide this property are borosilicate microspheres, although other agents are contemplated by the instant invention.

Preferred borosilicate microspheres for providing maximal emissivity are available from 3M and are designated SCOTCHLITE H50/10,000 EPX, having a target isotactic strength of 10,000 psi and a true density of 0.50 g/cc and SCOTCHLITE S60/10,000, having a target isotactic strength of 10,000 psi and a true density of 0.60 g/cc.

In a particularly preferred embodiment, diffuse reflectivity and reflectance were maximized over prior art formulations by utilizing a loading factor of about 8 oz (by wt) microspheres/gal and 2.5 lb TiO₂/gal. Results of this work are set forth in Table 1. It should be noted that heat formation is not linear. An increase in emissivity from 90 to 93 has a much greater effect on heat formation than does an increase in emissivity from 50 to 53. As one reaches the uppermost limits of possible emissivity each unit of increase has a profoundly greater effect on heat formation.

TABLE 1
TOTAL EMISSIVITY AND HEMISPHERICAL
SPECTRAL REFLECTANCE

| | Reflectance | Emissivity | |
|---|---|---|---|
| Specimen Code | Measured | Calculated | % Solar Reflectance |
| Prior Art | .10 | .90 | 80.7 |
| Instant Formulation | .07 | .93 | 82.4 |

Insulation results from using evacuated borosilicate microspheres as the diffuse reflector. Because they are evacuated they function as an insulator.

As an example; in one illustrative embodiment the formulation has a reflectivity of about 83%, an emissivity of about 93%, and an R value of about 5. This means that about 83% of the sunlight which strikes the coating is reflected and not available to be transduced into heat. About 93% of the remaining 17% is emitted and not accepted by the coating to be transduced into heat. This leaves a total of only about 1.19% of the initial radiant energy available to form heat, and since the transduction of radiant energy into “waste heat” is a fundamentally inefficient process, on the order of about 15%, one is left with only about 0.1785% of the original energy from the sun being converted into heat. This heat duty is further reduced by an insulating barrier with an R of 5 and by the utilization of some of the remaining heat by the endothermic components within the formulation. Thus, only a very minor amount of radiant energy (e.g. from the sun) is transferred to the building as heat. One method by which the coating works involves the use of a highly reflective additive (e.g. TiO₂), while another makes use of granules in the micrometer range to impart a microscopic granularity that results in diffuse reflectivity and emissivity, and an insulator. This latter property is augmented by the addition of the approximately 10μ phosphate salt particles.

Illustrative, albeit non-limiting embodiments include one in which the carrier is selected from polyurea, a water based paint, an oil based paint, an acrylic elastomeric formulation, an epoxy, or any similar coating composition, having included therein a reflective pigment, e.g. TiO₂ and borosilicate microspheres as both the granular and insular elements.

With respect to the fire retardant properties of the instant invention, they result from the combined efficacy of the evacuated borosilicate microspheres in combination with materials which undergo heat absorbing conformational changes. The high level of emissivity of the borosilicate has the effect of preventing much heat build up within the coating that comprises the instant invention, as well as providing some insulation, and the other retardant materials provide a mechanism by which much of the heat which then accrues is consumed rather than transmitted to the substrate below the coating.

Experimental Data:

Because the instant invention derives efficacy from numerous disparate and complimentary processes, it is possible to achieve results that were not previously possible. For example, most energy efficient coatings are fundamentally reflective, which limits their efficacy to formulations loaded with bright white pigment. In the case of this invention it is possible to provide colored coatings not possible earlier as a result of the profound inhibition of heat formation even in the presence of lowered reflectivity due to the extremely high levels of emissivity intrinsic to the invention. As mentioned earlier, the residual heat that is formed is addressed by mechanisms of insulation and fractional endothermic responses. Solar reflectance and emissivity values such as those presented earlier and below were determined by an independent contractor in order to evaluate energy saving properties of tinted coatings.

The results are set forth in the following table:

TABLE 2

| COATING/COLOR | REFLECTANCE | EMITTANCE |
|---|---|---|
| Borosilicate/White | 80.7 | 0.91 |
| Borosilicate/Beige | 59.6 | 0.87 |
| Borosilicate/Coral | 67.8 | 0.87 |
| Borosilicate/Apple Red | 42.6 | 0.89 |

With respect to fire resistance, inorganic salts with the ability to convert use heat as they shift their conformation to higher oxidation states (e.g., ammonium polyphosphate or monoammonium phosphate) alone or in combination with complexed water containing compounds capable of liberating water (e.g., borax decahydrate) and/or fire retardant urea based agents (e.g., melamine) may be included as heat reduction agents in greater or lesser amounts in the preparation of fire resistant materials, in a manner in accordance with the teachings of U.S. Pat. No. 4,438,028. Similarly, various silanes as described below maybe used. These compounds are endothermic in that with increasing ambient temperatures they undergo conformational changes that consume heat energy, thus they are useful in fire protection because they utilize heat that would otherwise be transmitted. Thus, the formulation works to prevent the formation of heat by radiant energy via reflectivity and emissivity, to prevent the transmission of conducted heat via emissivity, insulation and endothermic conformational changes, and to prevent the transmission of convected heat through insulation, emissivity, and conformational endothermic reactions.

Inclusion of these fire retarding agents is useful in the present coating formulation for two reasons. First, while the other elements of the coating formulation are very effective at reflecting and emitting thermal energy, they are not 100% effective and some small amount of residual heat is retained by a coated roof and transmitted into the coated structure. By adding an effective amount of agents known to utilize some of the transmitted heat, this heat is effectively consumed and cannot then be transmitted into the underlying coated structure, thus increasing the efficacy of the coating. Secondly, such inclusion serves to increase the fire retardant properties of the coating.

Effective ranges contemplated for inclusion of these ingredients are: Ammonium polyphosphate: between about 2 to about 10% by wt, with about 5 to about 8 wt % preferred; Monoammonium phosphate: between about 10 to about 50% by wt, with about 30 to about 40 wt % preferred. Borax: decahydrate about 5 to about 40% by weight Melamine: about 12 to about 40% by weight. 1,3,3-tribromopropyltrimethoxysilane or 1,3,3,3-tetrabromopropyltrimethoxysilane about 1.5 to about 30% by wt.

The preferred embodiment of this ingredient is comprised of particles of less than 10 microns in order to assure thorough dispersion throughout the coating. This is also a particulate size range that adds to the emissive properties of the formulation.

One preferred embodiment makes use of borosilicate microspheres, phosphate salts, a urea in the form of melarnine, and borax as borax decahydrate in the following ratios 8 oz per gallon borosilicate microspheres 5-8 wt. % ammonium polyphosphate 30-40 wt. % monoammonium phosphate 20-25, wt. % borax decahydrate 20-30, wt. % melamine 3-5 wt % 1,2-dibromoethyltrimethoxysilane

In order to best formulate this embodiment it is necessary to add a siliconated, silicic acid as well as the silane (or a stearate or other hydrophobic medium). A silicic acid in the amount of about 1-2.5 wt % based on the specific amounts of specific ingredients used improves the dispersibility, flowabiilty and wetting profile of the ingredients to improve their ability to mix and to increase their storage life. Similarly, the hydrophobizing effect of this process reduces water uptake during foam formation, which improves the production of polyurethane based foam products.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and drawings/figures. One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. An insulating, reflective, emissive and fire retardant homogeneous coating composition comprising:
evacuated borosilicate microspheres in an amount effective to result in an emissivity of about 93%, and a particle size of from about 5μm to about 65 μm;
at least one endothermic heat consuming compound in an amount effective to reduce or eliminate heat transmission, thereby effectuating fire retardant properties; and
a carrier selected from the group consisting of polyurea, a water based paint composition, an oil based paint composition, an acrylic elastomeric formulation,.an epoxy, or combinations thereof, said carrier present in an amount sufficient homogeneity of said composition;
wherein said coating composition has an insulating value of about R5.

2. The coating composition of claim 1 wherein said endothermic heat consuming compound is at least one member selected from the group consisting of borax decahydrate, melamine, ammonium polyphosphate and monoammonium phosphate, or. 1,2-dibromoethyltrimethoxysilane, 1,3,3-tribromopropyltrimethoxysilane or 1,3,3,3-tetrabromopropyltrimethoxysilane.

3. The coating composition of claim 2 wherein said endothermic heat consuming compound is ammonium polyphosphate and said ammonium polyphosphate is present in an amount between about 2% by wt to about 10% by wt.

4. The coating composition of claim 2 wherein said endothermic heat consuming compound is monoammonium phosphate and said monoammonium phosphate is present in an amount between about 10% by wt to about 30% by wt.

5. The coating composition of claim 2 wherein said endothermic heat consuming compound is borax decahydrate and said borax decahydrate is present in an amount between about 5% by wt to about 40% by wt.

6. The coating composition of claim 2 wherein said endothermic heat consuming compound is melamine and said melamine is present in an amount between about 12% by wt to about 40% by wt.

7. The coating composition of claim 2 wherein said endothermic heat consuming compound is 1,2-dibromoethyltrimethoxysilane, 1,3,3-tribromopropyltrimethoxysilane or 1,3,3,3-tetrabromopropyltrimethoxysilane and such silanes are present in an amount between about 1.5% by wt to about 30% by wt.

8. The coating composition of claim 1 wherein said evacuated microspheres have a particle size of about 5μm to about 50μm.

9. The coating composition of claim 1 wherein said microspheres are provided in an amount of about 8 ounces (wt) per gallon of coating composition.

10. The composition of claim 1 wherein said composition is applied to tents, clothing or similar fabric coverings to prevent the elevation of internal heat due to impinging radiant energy.

11. The coating composition of claim 1 wherein said composition is applied to buildings, vehicles, pipes, storage tanks, and similar structures to prevent combustion and retard the progress of fire.

12. A process for producing an article of manufacture having insulating, reflective, emissive, and fire retardant properties comprising:
providing at least one material selected from a group consisting of tents, clothing or similar fabric coverings; and
coating said material with a composition in accordance with claim 1, whereby insulating, reflective, emissive, and fire retardant properties are provided thereto.

13. A process for producing a structure having insulating, reflective, emissive, and fire retardant properties comprising:
providing at least one structure selected from a group consisting of buildings, vehicles, pipes,
storage tanks, and similar structures; and
coating said structure with a composition in accordance with claim 1,
whereby insulating, reflective, emissive, and fire retardant properties are provided thereto.

14. An insulating, reflective, emissive and fire retardant homogeneous coating composition comprising:
evacuated borosilicate microspheres in an amount effective to result in an emissivity of about 93%, said microspheres characterized by a true density of from about 0.50 to about 0.60 g/cc, a target isotactic strength of about 10,000 psi, and a particle size of from about 5 μm to about 65 μm;
at least one endothermic heat consuming compound in an amount effective to reduce or eliminate heat transmission, thereby effectuating fire retardant properties; and
a carrier selected from the group consisting of polyurea, a water based paint composition, an oil based paint composition, an acrylic elastomeric formulation, an epoxy, or combinations thereof, said carrier present in an amount sufficient homogeneity of said composition;
wherein said coating composition has an insulating value of about R5.

15. The coating composition of claim 14 wherein said endothermic heat consuming compound is at least one member selected from the group consisting of borax decahydrate, melamine, ammonium polyphosphate and monoammonium phosphate, or. 1,2-dibromoethyltrimethoxysilane, 1,3,3-tribromopropyltrimethoxysilane or 1,3,3,3-tetrabromopropyltrimethoxysilane.

16. The coating composition of claim 15 wherein said endothermic heat consuming compound is ammonium polyphosphate and said ammonium polyphosphate is present in an amount between about 2% by wt to about 10% by wt.

17. The coating composition of claim 15 wherein said endothermic heat consuming compound is monoammonium phosphate and said monoammonium phosphate is present in an amount between about 10% by wt to about 30% by wt.

18. The coating composition of claim 15 wherein said endothermic heat consuming compound is borax decahydrate and said borax decahydrate is present in an amount between about 5% by wt to about 40% by wt.

19. The coating composition of claim 15 wherein said endothermic heat consuming compound is melamine and said melamine is present in an amount between about 12% by wt to about 40% by wt.

20. The coating composition of claim 15 wherein said endothermic heat consuming compound is 1,2-dibromoethyltrimethoxysilane, 1,3,3-tribromopropyltrimethoxysilane or 1,3,3,3-tetrabromopropyltrimethoxysilane and such silanes are present in an amount between about 1.5% by wt to about 30% by wt.

21. The coating composition of claim 14 wherein said evacuated microspheres have a particle size of about 5μm to about 50μm.

22. The coating composition of claim 14 wherein said microspheres are provided in an amount of about 8 ounces (wt) per gallon of coating composition.

23. The composition of claim 14 wherein said composition is applied to tents, clothing or similar fabric coverings to prevent the elevation of internal heat due to impinging radiant energy.

24. The coating composition of claim 14 wherein said composition is applied to buildings, vehicles, pipes, storage tanks, and similar structures to prevent combustion and retard the progress of fire.

25. A process for producing an article of manufacture having insulating, reflective, emissive, and fire retardant properties comprising:
providing at least one material selected from a group consisting of tents, clothing or similar fabric coverings; and
coating said material with a composition in accordance with claim 14,
whereby insulating, reflective, emissive, and fire retardant properties are provided thereto.

26. A process for producing a structure having insulating, reflective, emissive, and fire retardant properties comprising:
providing at least one structure selected from a group consisting of buildings, vehicles, pipes, storage tanks, and similar structures; and
coating said structure with a composition in accordance with claim 14,
whereby insulating, reflective, emissive, and fire retardant properties are provided thereto.

27. An insulating, reflective, emissive and fire retardant homogeneous coating composition comprising:
a reflective pigment in an amount effective to provide from about 42.6 to about 85 percent solar reflectance;
evacuated borosilicate microspheres in an amount effective to result in an emissivity of about 93%, and a particle size of from about 5μm to about 65 μm;
at least one endothermic heat consuming compound in an amount effective to reduce or eliminate heat transmission, thereby effectuating fire retardant properties; and
a carrier selected from the group consisting of polyurea, a water based paint composition, an oil based paint composition, an acrylic elastomeric formulation, an epoxy, or combinations thereof, said carrier present in an amount sufficient homogeneity of said composition;
wherein said coating composition has an insulating value of about R5.

28. The coating composition of claim 27 wherein said endothermic heat consuming compound is at least one member selected from the group consisting of borax decahydrate, melamine, ammonium polyphosphate and monoammonium phosphate, or. 1,2-dibromoethyltrimethoxysilane, 1,3,3-tribromopropyltrimethoxysilane or 1,3,3,3-tetrabromopropyltrimethoxysilane.

29. The coating composition of claim 28 wherein said endothermic heat consuming compound is ammonium polyphosphate and said ammonium polyphosphate is present in an amount between about 2% by wt to about 10% by wt.

30. The coating composition of claim 28 wherein said endothermic heat consuming compound is monoammonium phosphate and said monoammonium phosphate is present in an amount between about 10% by wt to about 30% by wt.

31. The coating composition of claim 28 wherein said endothermic heat consuming compound is borax decahydrate and said borax decahydrate is present in an amount between about 5% by wt to about 40% by wt.

32. The coating composition of claim 28 wherein said endothermic heat consuming compound is melamine and said melamine is present in an amount between about 12% by wt to about 40% by wt.

33. The coating composition of claim 28 wherein said endothermic heat consuming compound is 1,2-dibromoethyltrimethoxysilane, 1,3,3-tribromopropyltrimethoxysilane or 1,3,3,3-tetrabromopropyltrimethoxysilane and such silanes are present in an amount between about 1.5% by wt to about 30% by wt.

34. The coating composition of claim 27 wherein said evacuated microspheres have a particle size of about 5μm to about 50μm.

35. The coating composition of claim 27 wherein said microspheres are provided in an amount of about 8 ounces (wt) per gallon of coating composition.

36. The composition of claim 27 wherein said composition is applied to tents, clothing or similar fabric coverings to prevent the elevation of internal heat due to impinging radiant energy.

37. The coating composition of claim 27 wherein said composition is applied to buildings, vehicles, pipes, storage tanks, and similar structures to prevent combustion and retard the progress of fire.

38. A process for producing an article of manufacture having insulating, reflective, emissive, and fire retardant properties comprising:
providing at least one material selected from a group consisting of tents, clothing or similar fabric coverings; and
coating said material with a composition in accordance with claim 27,
whereby insulating, reflective, emissive, and fire retardant properties are provided thereto.

39. A process for producing a structure having insulating, reflective, emissive, and fire retardant properties comprising:
providing at least one structure selected from a group consisting of buildings, vehicles, pipes, storage tanks, and similar structures; and
coating said structure with a composition in accordance with claim 27,
whereby insulating, reflective, emissive, and fire retardant properties are provided thereto.

40. An insulating, reflective, emissive and fire retardant homogeneous coating composition comprising:
a reflective pigment in an amount effective to provide from about 42.6 to about 85 percent solar reflectance;
evacuated borosilicate microspheres in an amount effective to result in an emissivity of about 93%, said microspheres characterized by a true density of from about 0.50 to about 0.60 g/cc, a target isotactic strength of about 10,000 psi, and a particle size of from about 5 μm to about 65 μm;
at least one endothermic heat consuming compound in an amount effective to reduce or eliminate heat transmission, thereby effectuating fire retardant properties; and
a carrier selected from the group consisting of polyurea, a water based paint composition, an oil based paint composition, an acrylic elastomeric formulation, an epoxy, or combinations thereof, said carrier present in an amount sufficient homogeneity of said composition;
wherein said coating composition has an insulating value of about R5.

41. The coating composition of claim 40 wherein said endothermic heat consuming compound is at least one member selected from the group consisting of borax decahydrate, melamine, ammonium polyphosphate and monoammonium phosphate, or. 1,2-dibromoethyltrimethoxysilane, 1,3,3-tribromopropyltrimethoxysilane or 1,3,3,3-tetrabromopropyltrimethoxysilane.

42. The coating composition of claim 41 wherein said endothermic heat consuming compound is ammonium polyphosphate and said ammonium polyphosphate is present in an amount between about 2% by wt to about 10% by wt.

43. The coating composition of claim 41 wherein said endothermic heat consuming compound is monoammonium phosphate and said monoammonium phosphate is present in an amount between about 10% by wt to about 30% by wt.

44. The coating composition of claim 41 wherein said endothermic heat consuming compound is borax decahydrate and said borax decahydrate is present in an amount between about 5% by wt to about 40% by wt.

45. The coating composition of claim 41 wherein said endothermic heat consuming compound is melamine and said melamine is present in an amount between about 12% by wt to about 40% by wt.

46. The coating composition of claim 41 wherein said endothermic heat consuming compound is 1,2-dibromoethyltrimethoxysilane, 1,3,3-tribromopropyltrimethoxysilane or 1,3,3,3-tetrabromopropyltrimethoxysilane and such silanes are present in an amount between about 1.5% by wt to about 30% by wt.

47. The coating composition of claim 40 wherein said evacuated microspheres have a particle size of about 5μm to about 50μm.

48. The coating composition of claim 40 wherein said microspheres are provided in an amount of about 8 ounces (wt) per gallon of coating composition.

49. The composition of claim 40 wherein said composition is applied to tents, clothing or similar fabric coverings to prevent the elevation of internal heat due to impinging radiant energy.

50. The coating composition of claim 40 wherein said composition is applied to buildings, vehicles, pipes, storage tanks, and similar structures to prevent combustion and retard the progress of fire.

51. A process for producing an article of manufacture having insulating, reflective, emissive, and fire retardant properties comprising:
providing at least one material selected from a group consisting of tents, clothing or similar fabric coverings; and
coating said material with a composition in accordance with claim 40,
whereby insulating, reflective, emissive, and fire retardant properties are provided thereto.

52. A process for producing a structure having insulating, reflective, emissive, and fire retardant properties comprising:
providing at least one structure selected from a group consisting of buildings, vehicles, pipes, storage tanks, and similar structures; and
coating said structure with a composition in accordance with claim 40,
whereby insulating, reflective, emissive, and fire retardant properties are provided thereto.

53. An insulating, reflective, emissive and fire retardant homogeneous coating composition comprising:
about 8oz per gallon borosilicate microspheres;
about 5-8 wt. % ammonium polyphosphate;
about 30-40 wt. % monoammonium phosphate;
about 20-25, wt. % borax decahydrate;
about 20-30, wt. % melamine;
about 3-5 wt % 1,2-dibromoethyltrimethoxysilane;
wherein said composition is formulated in the presence of from about 1-2.5 wt % of a silicic acid.

54. The composition of claims 53 where in the formulation further includes: about 2.5 lbs (wt) TiO₂ per gallon.
